(19) United States
(12) Patent Application Publication
(10) Pub. No.: US 2026/0339927 A1
(43) Pub. Date: Oct. 29, 2026

(54) SETTING USER EXPECTATIONS FOR DELAYED RESPONSES IN VOICE-BASED SYSTEMS

(71) Applicant: Toyota Jidosha Kabushiki Kaisha, Toyota-shi Aichi-ken (JP)

(72) Inventors: Alexander Charles Granieri, Mountain View, CA (US); Tyler La Monda, Fairfield, CA (US)

(73) Assignee: Toyota Jidosha Kabushiki Kaisha, Toyota-shi Aichi-ken (JP)

(21) Appl. No.: 19/191,678

(22) Filed: Apr. 28, 2025

(51) Int. Cl. G06F 16/242; B60K 35/10; B60K 35/26; G10L 15/22

(52) U.S. Cl. CPC G06F 16/2425; B60K 35/10; B60K 35/265; G10L 15/22; B60K 2360/148

(57) ABSTRACT

Systems, methods, and other embodiments described herein relate to setting user expectations for AI-based searches. In one embodiment, a method includes executing a query using an artificial intelligence (AI)-based search according to an initial query plan. The method includes determining a quality of an initial result of the query. The method includes, responsive to identifying that the quality of the initial result does not satisfy a quality threshold, (i) providing an explanation of the quality that indicates why the initial result does not satisfy the quality threshold, and (ii) executing the query using the AI-based search according to an extended query plan. The method includes providing at least one of the initial result and an extended result from executing the query using the extended query plan.

### TECHNICAL FIELD

The subject matter described herein relates, in general, to setting user expectations regarding search results and, more particularly, to explaining the quality of initial search results to set user expectations about the search process while executing an in-depth search.

### BACKGROUND

The rapid advancement of artificial intelligence (AI) has significantly enhanced the capabilities of search engines, enabling them to return highly relevant results in response to user queries. However, despite these advancements, there remain challenges in handling complex, ambiguous, or highly specific queries where immediate, high-quality results are not readily available. Current AI-powered search engines typically prioritize speed, returning results quickly even when the quality or relevance of those results is suboptimal.

When a search engine encounters difficulty in retrieving satisfactory results within an expected timeframe, it may provide irrelevant, generic, or incomplete responses rather than acknowledging the need for additional processing time. This can lead to user frustration, reduced trust in the search engine's capabilities, and repeated query reformulation efforts by the user. Users may misinterpret poor initial results as an indication that better results do not exist or may abandon their queries altogether.

Existing systems lack an effective mechanism to manage user expectations when high-quality results require extended processing times. Users are not given clear indications when an AI search system is actively working on improving the results beyond the initial response. Without such an expectation-setting mechanism, search engines fail to maintain engagement and confidence in their ability to provide useful and accurate information.

### SUMMARY

Example systems and methods relate to a manner of setting user expectations for AI-based searches. As previously noted, AI-based searching can experience different difficulties in relation to the quality of search results and the time it takes for the AI-based searching to generate results. In general, search engines that implement artificial-intelligence-based algorithms tend to be designed to prioritize the speed of a response over the quality of the results. That is, because users are typically impatient and expect results within a limited time window (e.g., 5 seconds), AI-based search engines are biased to provide the results within this window without regard to the quality of the results. This leaves the user as the arbiter of the quality of the results, which can lead to inaccurate information being construed as legitimate, stale information as new, and so on. Ultimately, the confidence of the user in the search engine can be diminished because of the various difficulties.

The present approach aims to directly involve the user in the process undertaken by the search engine and set user expectations according to the results that are acquired. For example, in one approach, the search system initially acquires a search from a user. The search may take different forms but is generally voice-based and can involve any subject matter including contextual aspects relating to the current environment of the user for which the query may include sensor data from a vehicle or other device that is servicing the request. In any case, the system executes the query under an initial query plan. Executing the search using the initial query plan controls the AI-based search to return the initial result in a temporally sensitive manner, such that the search does not, for example, engage in retrieving additional sources beyond a base knowledge set. As a result, the system is able to quickly generate results, but the results may not have the desired quality. That is, the results may include stale or inaccurate information.

Therefore, the system analyzes the results to quantify the quality of the initial result. In at least one approach, the system defines a metric that quantifies different quality-related characteristics of the results. For example, the metric may quantify a number of sources, the presence of conflicting results, staleness of sources, reliability of sources, bias of sources, and so on. Thus, the system is able to use the quality as an indicator of at least an accuracy and a relevance of the results. By way of example, the generated quality metric can indicate when too few sources or unreliable sources are used to generate the result. Similarly, the quality metric can indicate when the result may be stale.

In any case, the system uses the quality metric as a way of setting the expectations of the user about the result. Thus, when the quality fails to satisfy a quality threshold that defines, for example, a minimum standard for considering the results to be accurate/relevant, the system, in one approach, generates an explanation that is provided to the user and then proceeds to execute the query according to an extended query plan that causes the system to perform a more rigorous search. The explanation may indicate why the results are not considered to be reliable and can further specify that the system will continue searching to improve the results.

As such, under the extended query plan, the system involves additional resources (e.g., additional databases, documents, etc.) and does not restrict the time for executing the query. Consequently, the results from the extended search are more likely to be of a higher quality, which the system may iteratively assess until reaching the quality threshold. Once the system obtains acceptable results, the system can then present the results to the user and may further indicate the basis for specifying the quality of the results to support the confidence of the user in the result. In this way, the system can improve search results while maintaining user expectations, thereby improving searching with an AI-based search utility.

In one embodiment, a query system is disclosed. The query system includes one or more processors and a memory communicably coupled to the one or more processors. The memory stores instructions that, when executed by the one or more processors, cause the one or more processors to acquire a query. The instructions include instructions to execute the query using an artificial intelligence (AI)-based search according to an initial query plan. The instructions include instructions to determine a quality of an initial result of the query. The instructions include instructions to, responsive to identifying that the quality of the initial result does not satisfy a quality threshold, (i) provide an explanation of the quality that indicates why the initial result does not satisfy the quality threshold, and (ii) execute the query using the AI-based search according to an extended query plan. The instructions include instructions to provide at least one of the initial result and an extended result from executing the query using the extended query plan.

In one embodiment, a non-transitory computer-readable medium including instructions that, when executed by one or more processors, cause the one or more processors to perform one or more functions is disclosed. The instructions include instructions to acquire a query. The instructions include instructions to execute the query using an artificial intelligence (AI)-based search according to an initial query plan. The instructions include instructions to determine a quality of an initial result of the query. The instructions include instructions to, responsive to identifying that the quality of the initial result does not satisfy a quality threshold, (i) provide an explanation of the quality that indicates why the initial result does not satisfy the quality threshold, and (ii) execute the query using the AI-based search according to an extended query plan. The instructions include instructions to provide at least one of the initial result and an extended result from executing the query using the extended query plan.

In one embodiment, a method is disclosed. In one embodiment, a method includes executing a query using an artificial intelligence (AI)-based search according to an initial query plan. The method includes determining a quality of an initial result of the query. The method includes, responsive to identifying that the quality of the initial result does not satisfy a quality threshold, (i) providing an explanation of the quality that indicates why the initial result does not satisfy the quality threshold, and (ii) executing the query using the AI-based search according to an extended query plan. The method includes providing at least one of the initial result and an extended result from executing the query using the extended query plan.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements, or multiple elements may be designed as one element. In some embodiments, an element shown as an internal component of another element may be implemented as an external component and vice versa. Furthermore, elements may not be drawn to scale.

FIG. 1 illustrates one embodiment of a query system associated with setting user expectations for AI-based searches.

FIG. 2 illustrates a diagram of a query system within a cloud-computing environment.

FIG. 3 is a flowchart illustrating one embodiment of a method for setting user expectations in relation to the execution of an AI-based search.

FIG. 4 is an illustration of a scenario in which the query system implements an AI-based search to provide information about events in the surrounding environment of a vehicle.

FIG. 5 illustrates one embodiment of a vehicle within which systems and methods disclosed herein may be implemented.

### DETAILED DESCRIPTION

Systems, methods, and other embodiments associated with setting user expectations according to AI-based searches are disclosed. As previously noted, AI-based searching can experience different difficulties in relation to the quality of search results and the time it takes for the AI-based searching to generate results. Various approaches described herein address these issues by, for example, introducing an intelligent expectation-setting system that informs users when additional processing time is required to generate more accurate and relevant results. This system enhances the search experience by transparently communicating delays, offering estimated completion times, and potentially providing interim updates. By doing so, users are more likely to remain engaged, trust the search engine's capabilities, and achieve higher satisfaction with the results.

For example, in at least one aspect, the system clearly communicates the need for extended processing time to prevent users from assuming that the AI has failed or that no relevant information is available. Similarly, the system provides users with transparency about processing delays to build confidence in the system's ability to retrieve high-quality results. By allowing the AI-based search additional time to conduct a more thorough analysis, the system ensures that the final results are more accurate, relevant, and useful. Through these improvements, the system creates a more user-friendly, transparent, and effective AI search experience, bridging the gap between speed and quality in AI-powered search engines.

The present approach aims to directly involve the user in the process undertaken by the search engine and sets user expectations according to the results that are acquired. For example, in one approach, the search system initially acquires a search from a user. The search may take different forms but is generally voice-based and can involve any subject matter including contextual aspects relating to the current environment of the user for which the query may include sensor data from a vehicle or other device that is servicing the request. In any case, the system executes the query under an initial query plan. Executing the search using the initial query plan controls the AI-based search to return the initial result in a temporally sensitive manner, such that the search does not, for example, engage in retrieving additional sources beyond a base knowledge set. As a result, the system is able to quickly generate results, but the results may not have the desired quality. That is, the results may include stale or inaccurate information.

Therefore, the system analyzes the results to quantify the quality of the initial result. In at least one approach, the system defines a metric that quantifies different quality-related characteristics of the results. For example, the metric may quantify a number of sources, the presence of conflicting results, staleness of sources, reliability of sources, bias of sources, and so on. Thus, the system is able to use the quality as an indicator of at least an accuracy and a relevance of the results. By way of example, the generated quality metric can indicate when too few sources or unreliable sources are used to generate the result. Similarly, the quality metric can indicate when the result may be stale.

In any case, the system uses the quality metric as a way of setting the expectations of the user about the result. Thus, when the quality fails to satisfy a quality threshold that defines, for example, a minimum standard for considering the results to be accurate/relevant, the system, in one approach, generates an explanation that is provided to the user and then proceeds to execute the query according to an extended query plan that causes the system to perform a more rigorous search. The explanation may indicate why the results are not considered to be reliable and can further specify that the system will continue searching to improve the results.

As such, under the extended query plan, the system involves additional resources (e.g., additional databases, documents, etc.) and does not restrict the time for executing the query. Consequently, the results from the extended search are more likely to be of a higher quality, which the system may iteratively assess until reaching the quality threshold. Once the system obtains acceptable results, the system can then present the results to the user and may further indicate the basis for specifying the quality of the results to support the confidence of the user in the result. In this way, the system can improve search results while maintaining user expectations, thereby improving searching with an AI-based search utility.

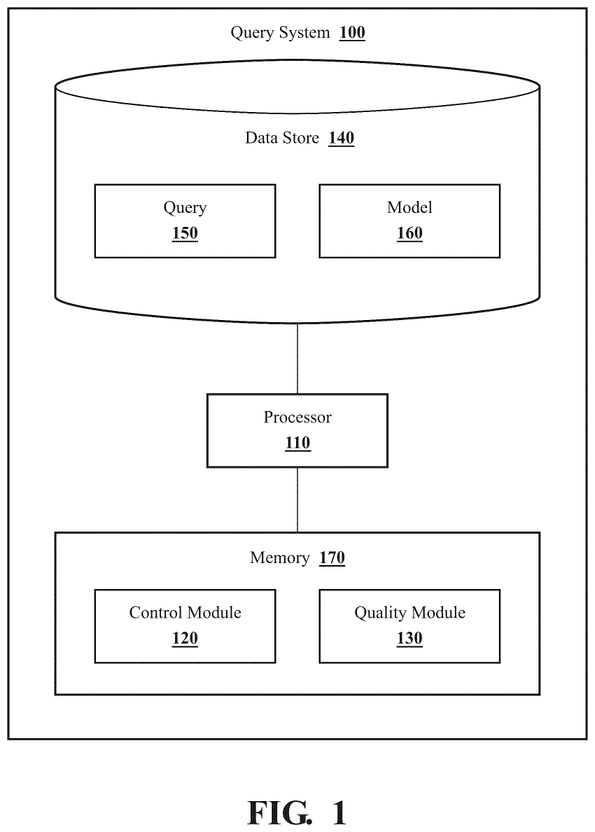

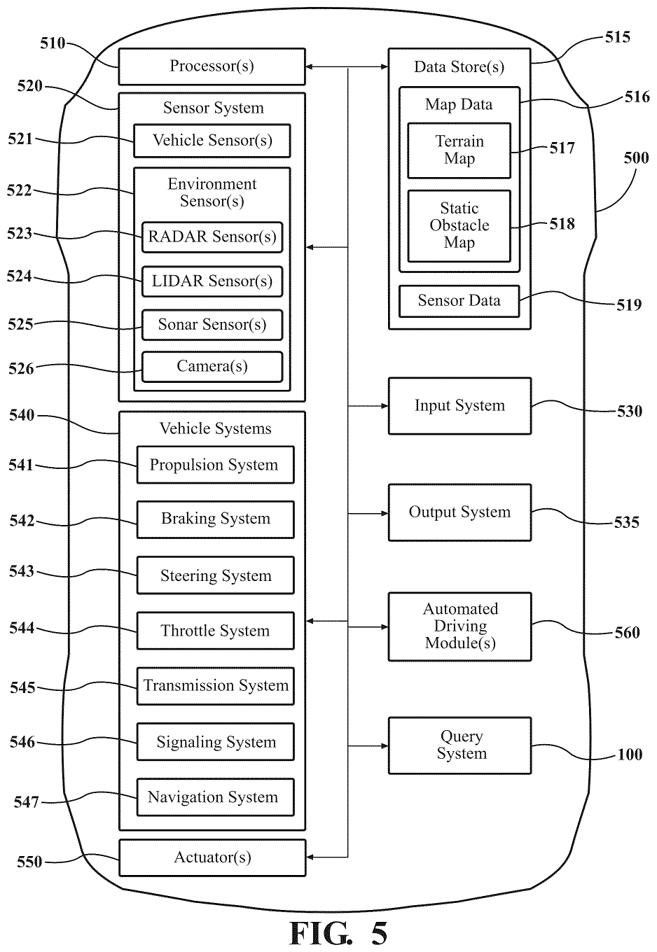

With reference to FIG. 1, one embodiment of a query system 100 is illustrated. The query system 100 is shown as including a processor 110, which may be from a vehicle 500 (e.g., processor 510) of FIG. 5 or may be associated with a separate computing device, such as a server, cloud-computing system, and so on. Accordingly, the processor 110 may be a part of the query system 100, the query system 100 may include a separate processor from the processor 510 of the vehicle 500, or the query system 100 may access the processor 110 through a data bus or another communication path.

In one embodiment, the query system 100 includes a memory 140 that stores a control module 120 and a quality module 130. The memory 140 is a random-access memory (RAM), read-only memory (ROM), a hard-disk drive, a flash memory, or another suitable memory for storing the modules 120 and 130. The modules 120 and 130 are, for example, computer-readable instructions that, when executed by the processor 110, cause the processor 110 to perform the various functions disclosed herein. In alternative arrangements, the modules 120 and 130 are independent elements from the memory 140 that are, for example, comprised of hardware elements (e.g., arrangements of logic gates). Thus, the modules 120 and 130 are alternatively ASICs, hardware-based controllers, a composition of logic gates, or another hardware-based solution.

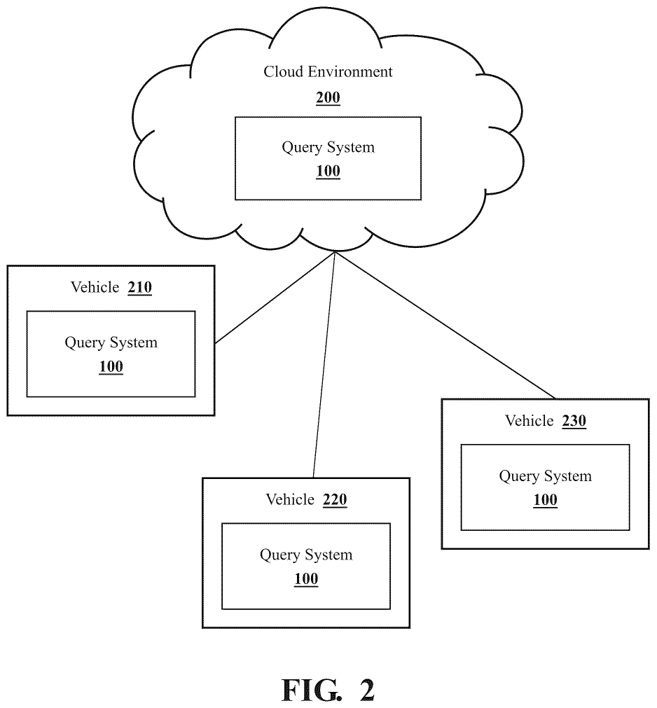

The query system 100, as illustrated in FIG. 1, is generally an abstracted form of the query system 100 as may be implemented between the vehicle 500 and a cloud-computing environment 200. FIG. 2 illustrates one example of a cloud-computing environment 200 that may be implemented along with the query system 100. As illustrated in FIG. 2, the query system 100 is embodied at least in part within the cloud-computing environment 200.

As shown, the query system 100 may include separate instances within one or more entities of the cloud-based environment 200, such as servers, and also instances within vehicles 210, 220, and 230 that function cooperatively to execute the queries and output the noted information. In a further aspect, the entities that implement the query system 100 within the cloud-based environment 200 may vary beyond transportation-related devices and encompass mobile devices (e.g., smartphones) and other devices that may benefit from the functionality discussed herein. Thus, the set of entities that function in coordination with the cloud environment 200 may be varied.

In one approach, functionality associated with at least one module of the query system 100 is implemented within the vehicle 500, while further functionality is implemented within a cloud-based computing system. Thus, the query system 100 may include a local instance at the vehicle 500 and a remote instance that functions within the cloud-based environment. Of course, while discussed in a cloud context, in various arrangements, the query system 100 may be wholly implemented within a vehicle or within a cloud-based resource.

Moreover, the query system 100, as provided for herein, may function in cooperation with a communication system. In one embodiment, the communication system communicates according to one or more communication standards. For example, the communication system can include multiple different antennas/transceivers and/or other hardware elements for communicating at different frequencies and according to respective protocols. The communication system, in one arrangement, communicates via a communication protocol, such as a WiFi, DSRC, V2I, V2V, or another suitable protocol for communicating between the vehicle and other entities in the cloud environment. Moreover, the communication system, in one arrangement, further communicates according to a protocol, such as a global system for mobile communication (GSM), Enhanced Data Rates for GSM Evolution (EDGE), Long-Term Evolution (LTE), 5G, or another communication technology that provides for the vehicle communicating with various remote devices (e.g., a cloud-based server). In any case, the query system 100 can leverage various wireless communication technologies to provide communications to other entities, such as members of the cloud-computing environment.

With continued reference to FIG. 1, in one embodiment, the query system 100 includes the data store 170. The data store 170 is, in one embodiment, an electronic data structure stored in the memory 140 or another data storage device that is configured with routines that can be executed by the processor 110 for analyzing stored data, providing stored data, organizing stored data, and so on. Thus, in one embodiment, the data store 170 stores data used by the modules 120 and 130 in executing various functions. In one embodiment, the data store 170 stores the query 150, the model 160, and/or other information used by the query system 100.

The control module 120 generally includes instructions that function to control the processor 110 to acquire the query 150. The control module 120 may acquire the query 150 in different ways depending on the particular implementation. For example, within the context of the vehicle 500, the control module 120 may access and/or control various systems and devices to acquire the query 150. In the instance where the query 150 is audio that is spoken by a user (i.e., a speech-based query), the control module 120 may access a microphone within the vehicle 500 along with, for example, one or more resources for performing audio processing. In further arrangements, the control module 120 may acquire the query 150 via a direct text-based input from a user interface (e.g., touch-based display) of the vehicle 500, and/or a combination of the noted inputs.

Additionally, while the query 150 has been discussed as purely including explicit information from the user in the context of the above noted options, the query 150 may further include additional contextual information, such as sensor data from the vehicle 500 about a surrounding environment, a current state of the user, a current state of the vehicle 500, a current location of the vehicle 500, gestures from the user, and so on. Consequently, the control module 120, in various arrangements, controls one or more sensors of an associated device (e.g., sensor system 520 of the vehicle 500) to acquire sensor data, which may be fused together as a single observation when derived from multiple different sources. In any case, the control module 120 can embed the sensor data with the query 150 in order to provide additional contextual information with the query 150.

The control module 120, after acquiring the query 150, then uses the model 160 or a sub-model thereof to execute the AI-based search according to an initial query plan. The initial query plan defines characteristics of how the query system 100 is to execute the query 150. For example, because users typically favor timeliness in relation to the delivery of the results, especially in the context of first providing the query 150, the initial query plan, in one or more arrangements, is configured to bias the timeliness of results as opposed to the quality of the results. For example, the initial query plan may limit the number of sources, the type of model used to perform the search, computing resources, and the overall permissible time. By way of example, in one instance, the initial query plan indicates that the model 160 is to execute up to a defined time threshold (e.g., 10 s).

In further arrangements, the initial query plan defines the model or models that can be used for the initial query. For example, model 160 may be a single large model or may be comprised of multiple sub-models. The sub-models are, for example, machine-learning models, which may have subject matter expertise or that may be trained on general knowledge. Thus, the initial query plan may specify a less complex model (e.g., an LLM with fewer parameters), which may execute more quickly over a limited set of knowledge. In any case, the control module 120 leverages the model 160 to perform the AI-based search. It should be appreciated that the model 160 may execute the search by using available knowledge resources, including learned knowledge about various topics, including information that is learned or otherwise obtained from secondary resources, such as websites, databases, document repositories, and so on.

The model 160 itself may take different forms depending on the particular implementation. For example, in one approach, the model 160 is a large language model (LLM), which is a transformer-based architecture. The model 160, in general, accepts the query 150 and then executes a search to determine results. While the model 160 is described as a discrete element, in various approaches, the model 160 may include different components. For example, in at least one arrangement, the model 160 is composed of multiple sub-models. That is, instead of using one large LLM, the model 160 may include multiple sub-models that have separate expertise. Thus, one of the sub-models may be a general knowledge model that initially generates results to a query based on a general knowledge of many different topics, and the other sub-models may have specific knowledge of different topics, such as physics, chemistry, sports, vehicles, architecture, etc. Accordingly, in more refined/directed queries, the control module 120 may leverage the sub-models with subject matter expertise, such as when executing a query using the extended query plan.

Additionally, the model 160 may have a different number of parameters depending on the particular implementation. That is, the general knowledge form of the model 160 may have more parameters than the subject matter-specific sub-models, as one example. Overall, the model 160 can be implemented to provide AI-based searching in various ways, leveraging the capabilities of large language models (LLMs) to enhance search functionality. In one approach, the control module 120 may implement the model 160 to use Retrieval-Augmented Generation (RAG), where an LLM is supplemented with a search engine to access external information. This approach allows the model 160 to retrieve relevant data from a database or knowledge base, enabling it to generate more accurate and contextually relevant responses without relying solely on the scope of training data used to train the model 160 itself. RAG is particularly useful for keeping information up-to-date and for providing sources for the generated content.

Another approach that the query system 100 may implement for the AI-based search is a hybrid search, which combines traditional keyword-based searching with vector-based semantic search. In this approach, the control module 120 implements the model 160 with a keyword search (e.g., BM25) that handles exact term matching, while also implementing vector search to capture the semantic meaning of queries and documents. By adjusting parameters like the alpha value, the query system 100 can control the weighting between keyword and vector search results to optimize relevance. This fusion allows for more nuanced search capabilities, accommodating both precise term matches and broader conceptual understanding.

The model 160 can also leverage the LLM architecture to play a significant role in query understanding. By leveraging LLMs, the query system 100 provides a mechanism that can interpret natural language queries and translate them into structured formats like SQL, enabling the execution of complex searches over structured data. For instance, a question like “What is the average age of country music singers in the United States?” can be converted into an SQL query to retrieve accurate results from a database, which the model 160 can then interpret to provide the result. This capability bridges the gap between unstructured user input and structured data retrieval, enhancing the flexibility and power of the searching mechanism within the query system 100.

Furthermore, the model 160, when, for example, implemented as an LLM, contributes to index construction by summarizing long documents, extracting structured data from unstructured text, and converting structured data into textual descriptions for vectorization. These processes, implemented by the query system 100, improve the efficiency and effectiveness of search indexes, allowing for better retrieval of relevant information. For example, summarizing lengthy texts enables the creation of concise representations that can be more easily searched semantically.

In addition to retrieval and indexing, the control module 120 can leverage the model 160 to enhance searching through re-ranking of search results. After an initial set of results is retrieved, the model 160 can assess and reorder the results based on relevance, recency, or other criteria. This re-ranking process ensures that the most pertinent information is presented, improving the overall search experience. Moreover, the model 160 can provide explanations for the ranking decisions, increasing transparency and user trust in the search system. In yet further implementations, the control module 120 may implement the model 160 to rewrite the query 150 provided as the initial input. For example, the model 160 may break the initial prompt into multiple sub-components, separate search the sub-components using various sources (e.g., sub-models, databases, etc.), and then analyze the results to rank and reorder the results for relevancy and easy understanding. These various implementations demonstrate the versatility of the AI-based search of the query system 100. By integrating the model 160 into different components of the AI-based search, retrieval, understanding, indexing, and ranking, the query system 100 can create more intelligent, responsive, and user-friendly search experiences.

After executing the initial query, the quality module 130, in at least one approach, analyzes the initial results of the query 150 to assess the quality. In order to understand how well the results of the query 150 meet the original request, the query system 100 leverages a quality metric that assesses the quality and provides for optimizing search results. A high-quality query typically yields relevant, accurate, and comprehensive results, while a low-quality query may be vague, overly broad, or ambiguous. There are several strategies and metrics to evaluate query quality from both user-centric and system-centric perspectives.

1. Relevance of results: one of the most direct ways to assess the quality is by evaluating the relevance of the search results. If the query 150 initially returns results that closely match the intent of the query 150, it's likely a high-quality query. Thus, the system 100 may implement a quality metric that quantifies precision, recall, and/or normalized discounted cumulative gain (nDCG), which considers both the presence and ranking of relevant results. For example, consider that cumulative gain (CG) alone is a general assessment of overall relevance and generally involves adding relevancy scores together for discrete results (e.g., documents), while discounted cumulative gain (DCG) considers the order of the results by further incorporating a penalty for misordering relevant results. nDCG considers both the relevancy and the ranked position of results within a list in order to present a logical listing of the results.

As part of relevancy, the quality module 130 may further consider the precision of the results, which indicates how many of the returned results are relevant. This part of the metric does not consider what was missed or otherwise not returned, but instead assesses whether each reference within the result set is relevant. In one approach, the quality module 130 determines the precision by simply dividing the number of relevant results by the total number of results. In various approaches, the quality module 130 may further implement a recall metric, which indicates how many of the relevant results were found out of a total possible number of relevant results. Of course, this metric requires knowledge of the complete possible set of relevant results, which may not be available for a given query. In any case, when the quality module 130 is able to access information about the total set of relevant results, then this additional component may be included in the metric.

2. Semantic Clarity and Specificity: the quality module 130 can further judge the query quality according to the clarity and specificity of the original query 150. For example, ambiguous queries often result in scattered or irrelevant results. The query system 100 can leverage Natural Language Processing (NLP) techniques to help identify vague terms or multiple interpretations. For example, a query like “best restaurant” is too broad, while “best restaurant for gropus to sit outdoors” is much more targeted and likely to produce useful results. As such, the quality module 130, in one or more arrangements, can identify vague/ambiguous queries and modify such queries and/or adjust the quality determination based on a quantification of the clarity/specificity of the query 150 itself.

3. Accuracy and completeness: the quality module 130 may further quantify the factual correctness and completeness of the results as part of the quality metric. For example, in at least one arrangement, the quality module 130 determines a number of sources supporting the result, a reliability of the sources, whether sources contradict one another, a staleness or age of the sources, and whether separate components of the result are supported by correlating sources or not. The quality module 130 may implement different routines to quantify the separate aspects related to accuarcy and completeness. In one example, the quality module 130 leverages a threshold (e.g., defined number) of sources in relation to assessing the overall number of cited sources. For the reliability of sources, the quality module 130 can track different sources and learn a retraction rate, how common alternative explanations arise from other sources, or leverage a watchdog or other sources that tracks the reliability. For identifying contradicting sources, the quality module 130 may leverage a separate assessment model that analyzes each source used in the result to identify when they contradict or may use another service that identifies contradicting information. Overall, assessing query quality involves a combination of evaluating output relevance, query structure, sources, and other information associated with the results. These insights inform the system about whether a result can be trusted or should be provided with an indication about the quality.

Consequently, in at least one arrangement, the quality module 130 further functions to provide an explanation about the results of the query 150 once acquired. For example, the quality module 130 may assess the initial query results in relation to a quality threshold. The quality threshold may embody different components for the different aspects of the quality metric or may be a single combined value. In any case, the quality threshold quantifies a baseline quality for providing the results of the query 150.

That is, in one or more arrangements, when the quality module 130 determines that the quality of the query 150 does not satisfy the quality threshold (e.g., fails to meet or exceed defined values of the threshold), then the quality module 130 provides an explanation of the quality to a user. In one approach, providing the explanation may involve generating spoken audio that generally indicates the quality of the results do not meet the quality threshold. In a further aspect, the quality module 130 may specify the particular reason that the results are lacking in quality, e.g., conflicting sources, sources are unreliable, not enough sources, etc.

For example, the quality module 130 may provide a statement similar to the following: “Here is what I found [in the time allotted] or [according to the resources available]—would you like me to search further?” or “The results I found are not supported by reliable sources. I will search further in the background and let you know when better results are identified.” Alternatively, the quality module 130 may generate a response such as: “I'll keep thinking about this and get back to you when I have a better result.” In the noted examples, the quality module 130 is setting the user expectation about the results and indicating that more robust searching may take place, but this additional searching may take more time. This may further involve providing an option to continue searching or not.

In any case, the control module 120 may then proceed by executing the query 150 according to an extended query plan. Similar to the initial query plan, the extended query plan defines how the control module 120 executes the search. However, the extended search plan generally defines a more robust search than the initial query plan. That is, for example, the extended search plan may specify additional resources to investigate (e.g., social media, databases, document repositories, websites, etc.), additional computing resources to use (e.g., additional processor bandwidth and/or time), additional functions (e.g., retrieval augmented generation (RAG)), additional sub-models to execute, and so on. Overall, the extended query plan expands the available resources so that the control module 120 can leverage the model 160 to better search the query 150. As a result, the results from the query 150 under the extended query plan are more likely to be of an acceptable quality.

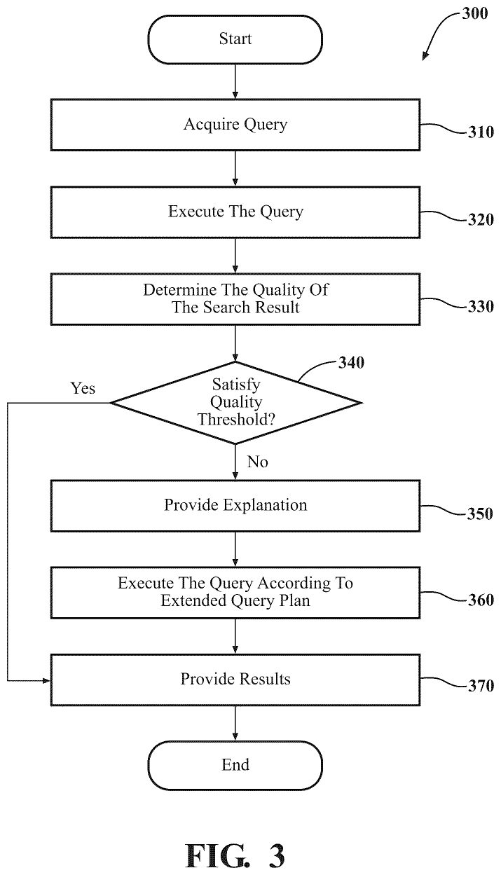

Additional aspects of the query system 100 will be discussed in relation to FIG. 3. FIG. 3 illustrates a flowchart of a method 300 that is associated with setting user expectations according to AI-based searches. Method 300 will be discussed from the perspective of the query system 100 of FIG. 1, and 2. While method 300 is discussed in combination with the query system 100, it should be appreciated that the method 300 is not limited to being implemented within the query system 100 but is instead one example of a system that may implement the method 300.

At 310, the control module 120 acquires the query 150. As noted previously, the query 150 may be a voice-based inquiry from a passenger within a vehicle. Thus, the control module 120 may control one or more sensors (e.g., microphone, camera, etc.) to observe the passenger and obtain the query from the passenger speaking. Additionally, in various arrangements, the passenger may provide additional inputs, such as gestures (e.g., pointing) or typed inputs. Thus, the control module 120 may also acquire sensor data from the vehicle or another device that is implementing the query system 100 in order to contextualize the spoken/textual inputs. As one example, the passenger may point to an external environment of the vehicle and ask “what is that store with the line outside?” By collecting the sensor data about the external environment and also about gestures (e.g., pointing) by the passenger, the query system 100 is better able to contextualize the query 150, which may involve integrating various aspects of the sensor data into the query 150.

At 320, the control module 120 executes the query 150 according to an initial query plan. As previously outlined, the control module 120 executes the query 150 as an AI-based search that leverages the model 160. As noted, the model 160 is a machine-learning model, such as an LLM or a collection of LLMs. The control module 120 generally executes the search using the model 160, which may further leverage various resources, including documents, databases, online search engines, websites, and so on. However, the initial search is generally limited to a quick pass. That is, the query system 100 defines different query plans that define how the search is to be executed. As described herein, the query system 100 generally implements two separate query plans, an initial query plan and an extended query plan. It should be appreciated that the query system 100 may implement further query plans with different parameters, but two are described for purposes of discussion. The initial query plan includes, in one example, executing the query using a limited set of resources to limit a temporal consumption of the query. That is, the initial query is intended to be quick and to avoid the passenger waiting for the result. Thus, the initial query plan provides access to a limited set of resources, such as a general knowledge LLM without additional retrievable resources and with, in one arrangement, a time limit. In this way, the control module 120 ensures that the initial results are provided in a quick manner.

At 330, the quality module 130 determines a quality of the initial result. Determining the quality of the initial result includes analyzing the result according to a metric that quantifies different aspects about the results, such as a number of sources associated with the results, whether conflicting results are present, staleness of sources (i.e., how old the results are), reliability of sources, bias of sources, and so on. As noted previously, the quality metric can include multiple different components related to different aspects of the quality, but that generally quantify at least an accuracy and a relevance of the results.

At 340, the quality module 130 identifies whether the quality of the initial result satisfies a quality threshold or not. The quality threshold, as noted, may take different forms, which can include multiple separate threshold values or a single combined threshold value. The multiple separate values may be in relation to the various components listed previously. In the case of multiple thresholds or sub-thresholds, the quality module 130 may perform multiple comparisons and determine whether a sufficient number of thresholds are satisfied (e.g., met or exceeded) or not. However, in general, the quality module 130 simply compares a metric that quantifies the quality of the initial result against the quality threshold to ascertain when the initial result is not adequate. When the quality module 130 determines that the results satisfy the quality threshold, then the query system 100 may proceed with providing the results, as described at 370. However, because the initial query is executed according to the initial query plan, which provides limited resources, the initial query may not provide quality results. Thus, when the quality module 130 determines that the quality does not satisfy the quality threshold, then the query system 100 proceeds with setting the user's expectations using an explanation of the results, as discussed at 350.

At 350, the quality module 130 provides an explanation of the results. In at least one approach, the quality module 130 uses the assessment of the quality in relation to the generation of the quality metric and the comparison with the quality threshold to determine which aspects of the query 150 failed to produce quality results. For example, the quality module 130 can identify which components of the quality metric did not meet the quality threshold, such as a number of sources, or the reliability of available sources. From this information, the quality module 130 generates an output to the user explaining the quality of the results. For example, the output may be a voice-based agent speaking the explanation to the user. As one example, the output may state: “I found results for your query; however, because the number of sources is sparse and the reliability of those sources is questionable, I will continue to search for a better answer.” The quality module 130 may then proceed with providing the results as part of the explanation, which may depend on the user indicating their desire to receive the results or not. Thus, even though the results may not satisfy the quality threshold, the quality module 130 may still provide the results along with the explanation at 350.

At 360, the control module 120 executes the query 150 using the AI-based search according to an extended query plan. As noted previously, the extended query plan generally provides for a more robust search according to one or more parameters of how the search is executed relative to the initial query plan. Thus, the extended query plan may not emphasize the speed of search as much as the thoroughness or detail of the search. In one or more arrangements, the extended query plan may provide no temporal limitations and simply executes until the quality of the result satisfies the quality threshold or is otherwise cancelled. This permits the model 160 to explore additional resources, thereby resulting in better quality results.

At 370, the control module 120 provides the results. It should be noted that while providing the results is shown as a serial step after executing the query 150 using the extended query plan, the control module 120 may continue to search and provide results to the quality module 130 for assessment of the quality before proceeding to provide the results at 370. In this way, the query system 100 is able to ensure that the results provided at 370 meet the quality threshold. In an instance where the query system 100 is not able to find any results, the system may generate a message indicating this and may simply exit from processing the query 150. In general, finding no results may occur as a decision by the system according to an inability to identify sources, the expiration of a predefined time limit (e.g., one hour), the end of a current session (e.g., exiting the vehicle), or according to another defined limitation. In any case, the extended query plan is generally formulated such that a result that satisfies the quality threshold is likely to be found, but within an extended timeframe.

The control module 120 provides the result (i.e., the extended result or the initial result) by explicitly controlling one or more systems of the vehicle to generate an output. For example, in at least one arrangement, the control module 120 communicates the result to the passenger/occupant using a voice-based response. Accordingly, the system may leverage a chatbot and text-to-speech along with controlling an audio system in the vehicle to communicate the result to the user. In another example, the system 100 may leverage the speech-based response along with a display to provide a combined result. In yet further approaches, the control module 120 may provide various automated controls, such as automatically adjusting an electronic calendar of the user, adapting a current route for navigating the vehicle to include a point of interest or other result from the response. In the case of altering a route of the vehicle where the vehicle is functioning autonomously or at least semi-autonomously, the system 100 may adapt explicit control of the vehicle to modify a current trajectory in order to follow the modified route. In this way, the query system 100 is able to improve an AI-based search experience by setting user expectations and adapting the way in which the search is executed to provide quality results.

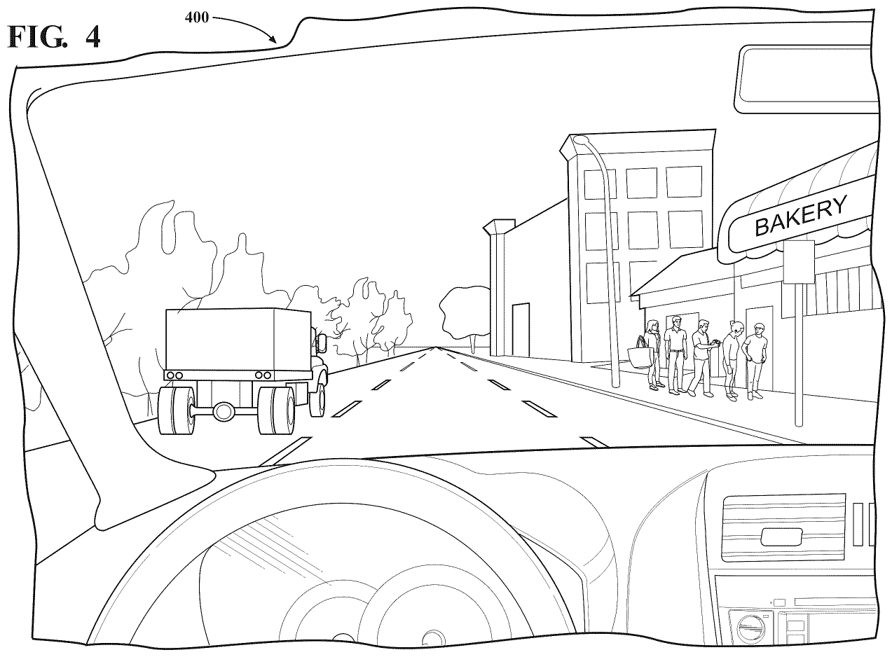

Referring to FIG. 4, one example of a search scenario 400 is illustrated. The scenario 400 a line of people are standing in front of a bakery along the side of the road. The user within the vehicle 500 points to the people standing in the line and states “why is there a line outside of the bakery?” The query system 100 generates the query using the spoken request of the user along with sensor data from the car that includes sensor data from the interior of the vehicle 500 that captures the user pointing at the line and also sensor data of the external environment depicting the bakery and the people. In a further aspect, the query system 100 may also acquire sensor data about a current state of the vehicle 500, such as a current GPS-based location.

The query system 100 then executes the query 150 using the initial query plan in order to provide a quick response to the user. The query system 100 responds in this case as follows: “I am not able to find any information about the line outside of the bakery. I will keep searching. However, if you would like to know the bakery hours, a menu, a phone number, or other information, please let me know. I will get back to you with further results later.” Thus, the query system 100 assesses the initial results and determines that even though information is available about the bakery, the quality of the results in relation to the explicit request do not satisfy the quality threshold.

Accordingly, the query system 100 continues with the search according to the extended query plan. Thus, the query system 100 includes additional resources, such as social media, and so on. From this, the query system 100 is able to identify additional information that satisfies the query. Thus, the query system 100 may then respond as follows: “I've found more detailed results about your earlier request. The line outside of the bakery is likely for a new release of specialty donuts that take the shape of members of the band Dire Straits. The band members are present for the release, which is likely why so many people are lining up at the bakery.” Accordingly, using the additional resources, the query system 100 is able to find the answer to the query 150 while doing so in a manner that is responsive to the user and sets expectations about the timing of the response.

Referring to FIG. 5, an example of a vehicle 500 is illustrated. As used herein, a “vehicle” is any form of transport that may be motorized or otherwise powered. In one or more implementations, the vehicle 500 is an automobile. While arrangements will be described herein with respect to automobiles, it will be understood that embodiments are not limited to automobiles. In some implementations, the vehicle 500 may be a robotic device or a form of transport that, for example, includes sensors to perceive aspects of the surrounding environment and thus benefits from the functionality discussed herein.

The vehicle 500 also includes various elements. It will be understood that in various embodiments it may not be necessary for the vehicle 500 to have all of the elements shown in FIG. 6. The vehicle 500 can have different combinations of the various elements shown in FIG. 6. Further, the vehicle 500 can have additional elements to those shown in FIG. 6. In some arrangements, the vehicle 500 may be implemented without one or more of the elements shown in FIG. 6. While the various elements are shown as being located within the vehicle 500 in FIG. 6, it will be understood that one or more of these elements can be located external to the vehicle 500. Further, the elements shown may be physically separated by large distances. For example, as discussed, one or more components of the disclosed system can be implemented within a vehicle while further components of the system are implemented within a cloud-computing environment or other system that is remote from the vehicle 500.

It will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In any case, the vehicle 500 includes a query system 100 that is implemented to perform methods and other functions as disclosed herein relating to improving mapping through synthesizing probe data.

FIG. 5 will now be discussed in full detail as an example environment within which the system and methods disclosed herein may operate. In some instances, the vehicle 500 is configured to switch selectively between an autonomous mode, one or more semi-autonomous modes, and/or a manual mode. “Manual mode” means that all of or a majority of the control and/or maneuvering of the vehicle is performed according to inputs received via manual human-machine interfaces (HMIs) (e.g., steering wheel, accelerator pedal, brake pedal, etc.) of the vehicle 500 as manipulated by a user (e.g., human driver). In one or more arrangements, the vehicle 500 can be a manually-controlled vehicle that is configured to operate in only the manual mode.

In one or more arrangements, the vehicle 500 implements some level of automation in order to operate autonomously or semi-autonomously. As used herein, automated control of the vehicle 500 is defined along a spectrum according to the SAE J3016 standard. The SAE J3016 standard defines six levels of automation from level zero to five. In general, as described herein, semi-autonomous mode refers to levels zero to two, while autonomous mode refers to levels three to five. Thus, the autonomous mode generally involves control and/or maneuvering of the vehicle 500 along a travel route via a computing system to control the vehicle 500 with minimal or no input from a human driver. By contrast, the semi-autonomous mode, which may also be referred to as advanced driving assistance system (ADAS), provides a portion of the control and/or maneuvering of the vehicle via a computing system along a travel route with a vehicle operator (i.e., driver) providing at least a portion of the control and/or maneuvering of the vehicle 500.

With continued reference to the various components illustrated in FIG. 5, the vehicle 500 includes one or more processors 510. In one or more arrangements, the processor(s) 510 can be a primary/centralized processor of the vehicle 500 or may be representative of many distributed processing units. For instance, the processor(s) 510 can be an electronic control unit (ECU). Alternatively, or additionally, the processors include a central processing unit (CPU), a graphics processing unit (GPU), an ASIC, a microcontroller, a system on a chip (SoC), and/or other electronic processing units that support operation of the vehicle 500.

The vehicle 500 can include one or more data stores 515 for storing one or more types of data. The data store 515 can be comprised of volatile and/or non-volatile memory. Examples of memory that may form the data store 515 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, solid-state drivers (SSDs), and/or other non-transitory electronic storage medium. In one configuration, the data store 515 is a component of the processor(s) 510. In general, the data store 515 is operatively connected to the processor(s) 510 for use thereby. The term “operatively connected,” as used throughout this description, can include direct or indirect connections, including connections without direct physical contact.

In one or more arrangements, the one or more data stores 515 include various data elements to support functions of the vehicle 500, such as semi-autonomous and/or autonomous functions. Thus, the data store 515 may store map data 516 and/or sensor data 519. The map data 516 includes, in at least one approach, maps of one or more geographic areas. In some instances, the map data 516 can include information about roads (e.g., lane and/or road maps), traffic control devices, road markings, structures, features, and/or landmarks in the one or more geographic areas. The map data 516 may be characterized, in at least one approach, as a high-definition (HD) map that provides information for autonomous and/or semi-autonomous functions.

In one or more arrangements, the map data 516 can include one or more terrain maps 617. The terrain map(s) 517 can include information about the ground, terrain, roads, surfaces, and/or other features of one or more geographic areas. The terrain map(s) 517 can include elevation data in the one or more geographic areas. In one or more arrangements, the map data 516 includes one or more static obstacle maps 518. The static obstacle map(s) 518 can include information about one or more static obstacles located within one or more geographic areas. A “static obstacle” is a physical object whose position and general attributes do not substantially change over a period of time. Examples of static obstacles include trees, buildings, curbs, fences, and so on.

The sensor data 519 is data provided from one or more sensors of the sensor system 520. Thus, the sensor data 519 may include observations of a surrounding environment of the vehicle 500 and/or information about the vehicle 500 itself. In some instances, one or more data stores 515 located onboard the vehicle 500 store at least a portion of the map data 516 and/or the sensor data 519. Alternatively, or in addition, at least a portion of the map data 516 and/or the sensor data 519 can be located in one or more data stores 515 that are located remotely from the vehicle 500.

As noted above, the vehicle 500 can include the sensor system 520. The sensor system 520 can include one or more sensors. As described herein, “sensor” means an electronic and/or mechanical device that generates an output (e.g., an electric signal) responsive to a physical phenomenon, such as electromagnetic radiation (EMR), sound, etc. The sensor system 520 and/or the one or more sensors can be operatively connected to the processor(s) 510, the data store(s) 515, and/or another element of the vehicle 500.

Various examples of different types of sensors will be described herein. However, it will be understood that the embodiments are not limited to the particular sensors described. In various configurations, the sensor system 520 includes one or more vehicle sensors 521 and/or one or more environment sensors. The vehicle sensor(s) 521 function to sense information about the vehicle 500 itself. In one or more arrangements, the vehicle sensor(s) 521 include one or more accelerometers, one or more gyroscopes, an inertial measurement unit (IMU), a dead-reckoning system, a global navigation satellite system (GNSS), a global positioning system (GPS), and/or other sensors for monitoring aspects about the vehicle 500.

As noted, the sensor system 520 can include one or more environment sensors 522 that sense a surrounding environment (e.g., external) of the vehicle 500 and/or, in at least one arrangement, an environment of a passenger cabin of the vehicle 500. For example, the one or more environment sensors 522 sense objects the surrounding environment of the vehicle 500. Such obstacles may be stationary objects and/or dynamic objects. Various examples of sensors of the sensor system 520 will be described herein. The example sensors may be part of the one or more environment sensors 522 and/or the one or more vehicle sensors 521. However, it will be understood that the embodiments are not limited to the particular sensors described. As an example, in one or more arrangements, the sensor system 520 includes one or more radar sensors 523, one or more LIDAR sensors 524, one or more sonar sensors 525 (e.g., ultrasonic sensors), and/or one or more cameras 526 (e.g., monocular, stereoscopic, RGB, infrared, etc.).

Continuing with the discussion of elements from FIG. 5, the vehicle 500 can include an input system 530. The input system 530 generally encompasses one or more devices that enable the acquisition of information by a machine from an outside source, such as an operator. The input system 530 can receive an input from a vehicle passenger (e.g., a driver/operator and/or a passenger). Additionally, in at least one configuration, the vehicle 500 includes an output system 535. The output system 535 includes, for example, one or more devices that enable information/data to be provided to external targets (e.g., a person, a vehicle passenger, another vehicle, another electronic device, etc.).

Furthermore, the vehicle 500 includes, in various arrangements, one or more vehicle systems 540. Various examples of the one or more vehicle systems 540 are shown in FIG. 5. However, the vehicle 500 can include a different arrangement of vehicle systems. It should be appreciated that although particular vehicle systems are separately defined, each or any of the systems or portions thereof may be otherwise combined or segregated via hardware and/or software within the vehicle 500. As illustrated, the vehicle 500 includes a propulsion system 541, a braking system 542, a steering system 543, a throttle system 544, a transmission system 545, a signaling system 546, and a navigation system 547.

The navigation system 547 can include one or more devices, applications, and/or combinations thereof to determine the geographic location of the vehicle 500 and/or to determine a travel route for the vehicle 500. The navigation system 547 can include one or more mapping applications to determine a travel route for the vehicle 500 according to, for example, the map data 516. The navigation system 547 may include or at least provide connection to a global positioning system, a local positioning system or a geolocation system.

In one or more configurations, the vehicle systems 540 function cooperatively with other components of the vehicle 500. For example, the processor(s) 510, the query system 100, and/or automated driving module(s) 560 can be operatively connected to communicate with the various vehicle systems 540 and/or individual components thereof. For example, the processor(s) 510 and/or the automated driving module(s) 560 can be in communication to send and/or receive information from the various vehicle systems 540 to control the navigation and/or maneuvering of the vehicle 500. The processor(s) 510, the query system 100, and/or the automated driving module(s) 560 may control some or all of these vehicle systems 540.

For example, when operating in the autonomous mode, the processor(s) 510, the query system 100, and/or the automated driving module(s) 560 control the heading and speed of the vehicle 500. The processor(s) 510, the query system 100, and/or the automated driving module(s) 560 cause the vehicle 500 to accelerate (e.g., by increasing the supply of energy/fuel provided to a motor), decelerate (e.g., by applying brakes), and/or change direction (e.g., by steering the front two wheels). As used herein, “cause” or “causing” means to make, force, compel, direct, command, instruct, and/or enable an event or action to occur either in a direct or indirect manner.

As shown, the vehicle 500 includes one or more actuators 550 in at least one configuration. The actuators 550 are, for example, elements operable to move and/or control a mechanism, such as one or more of the vehicle systems 540 or components thereof responsive to electronic signals or other inputs from the processor(s) 510 and/or the automated driving module(s) 560. The one or more actuators 550 may include motors, pneumatic actuators, hydraulic pistons, relays, solenoids, piezoelectric actuators, and/or another form of actuator that generates the desired control.

As described previously, the vehicle 500 can include one or more modules, at least some of which are described herein. In at least one arrangement, the modules are implemented as non-transitory computer-readable instructions that, when executed by the processor 510, implement one or more of the various functions described herein. In various arrangements, one or more of the modules are a component of the processor(s) 510, or one or more of the modules are executed on and/or distributed among other processing systems to which the processor(s) 510 is operatively connected. Alternatively, or in addition, the one or more modules are implemented, at least partially, within hardware. For example, the one or more modules may be comprised of a combination of logic gates (e.g., metal-oxide-semiconductor field-effect transistors (MOSFETs)) arranged to achieve the described functions, an application-specific integrated circuit (ASIC), programmable logic array (PLA), field-programmable gate array (FPGA), and/or another electronic hardware-based implementation to implement the described functions. Further, in one or more arrangements, one or more of the modules can be distributed among a plurality of the modules described herein. In one or more arrangements, two or more of the modules described herein can be combined into a single module.

Furthermore, the vehicle 500 may include one or more automated driving modules 560. The automated driving module(s) 560, in at least one approach, receive data from the sensor system 520 and/or other systems associated with the vehicle 500. In one or more arrangements, the automated driving module(s) 560 use such data to perceive a surrounding environment of the vehicle. The automated driving module(s) 560 determine a position of the vehicle 500 in the surrounding environment and map aspects of the surrounding environment. For example, the automated driving module(s) 560 determines the location of obstacles or other environmental features including traffic signs, trees, shrubs, neighboring vehicles, pedestrians, etc.

The automated driving module(s) 560 either independently or in combination with the query system 100 can be configured to determine travel path(s), current autonomous driving maneuvers for the vehicle 500, future autonomous driving maneuvers and/or modifications to current autonomous driving maneuvers based on data acquired by the sensor system 520 and/or another source. In general, the automated driving module(s) 560 functions to, for example, implement different levels of automation, including advanced driving assistance (ADAS) functions, semi-autonomous functions, and fully autonomous functions, as previously described.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-5, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. The systems, components and/or processes also can be embedded in a computer-readable storage, such as a computer program product or other data program storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. The phrase “computer-readable storage medium” means a non-transitory storage medium. A computer-readable storage medium may be, for example, an electronic, magnetic, optical, electromagnetic, infrared, or semiconductor system, apparatus, or device, or any suitable combination of the foregoing. A non-exhaustive list of the computer-readable storage medium can include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or a combination of the foregoing. In the context of this document, a computer-readable storage medium is, for example, a tangible medium that stores a program for use by or in connection with an instruction execution system or device.

Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through a network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

1. A query system, comprising:
one or more processors; and
a memory communicably coupled to the one or more processors and storing:
a control module including instructions that, when executed by the one or more processors, cause the one or more processors to:
execute a query, acquired in a vehicle, using an artificial intelligence (AI)-based search according to an initial query plan, wherein the initial query plan restricts the AI-based search to a limited set of local knowledge resources within a defined temporal threshold to limit a temporal consumption of the query;
determine a quality of an initial result of the query;
responsive to identifying that the quality of the initial result does not satisfy a quality threshold according to a metric, (i) provide, via a voice-based agent of the vehicle, an explanation of the quality that indicates why the initial result does not satisfy the quality threshold, including which part of the metric is a cause, and (ii) execute the query using the AI-based search according to an extended query plan that reallocates computational resources; and
provide, via a voice-based agent, at least one of the initial result and an extended result from executing the query using the extended query plan.

2. The query system of claim 1, wherein the instructions to determine the quality of the initial result include instructions to analyze the initial result according to the metric that quantifies a number of sources, conflicting results, staleness of sources, reliability of sources, and bias of sources, and
wherein the quality indicates at least an accuracy and a relevance.

3. The query system of claim 1, wherein the instructions to acquire the query include instructions to receive a voice-based inquiry from a passenger within a vehicle, and wherein acquiring the query includes receiving sensor data from the vehicle to contextualize the query with respect to a current location of the vehicle, a route of the vehicle, and environmental conditions.

4. The query system of claim 1, wherein the instructions to identify that the quality does not satisfy the quality threshold include instructions to compare the metric that quantifies the quality of the initial result against the quality threshold to ascertain when the initial result is not adequate.

5. The query system of claim 1, wherein the instructions to execute the query according to the initial query plan include instructions to execute the query using a limited set of resources to limit a temporal consumption of the query, and
wherein the AI-based search is a search engine that uses one or more machine-learning models in combination with resources, including documents, and online search engines.

6. The query system of claim 1, wherein the instructions to execute the query according to the extended query plan include instructions to execute the query without temporal limitations to permit the AI-based search to explore additional resources and improve the quality, including offloading the query to a remote entity.

7. The query system of claim 1, wherein the instructions to provide at least one of the initial result and the extended result include instructions to control one or more systems within a vehicle to communicate with a passenger, modify an electronic calendar of the passenger, or alter a route for navigating the vehicle, and
wherein the instructions to provide the explanation of the quality include instructions to use a voice-based agent to communicate the explanation to the passenger.

8. The query system of claim 1, wherein the instructions to acquire the query include instructions to acquire the query based on at least gestures of a user and spoken audio of the user in a vehicle.

9. A non-transitory computer-readable medium storing instructions that, when executed by one or more processors, cause the one or more processors to:
execute a query, acquired in a vehicle, using an artificial intelligence (AI)-based search according to an initial query plan, wherein the initial query plan restricts the AI-based search to a limited set of local knowledge resources within a defined temporal threshold to limit a temporal consumption of the query;
determine a quality of an initial result of the query;
responsive to identifying that the quality of the initial result does not satisfy a quality threshold according to a metric, (i) provide, via a voice-based agent of the vehicle, an explanation of the quality that indicates why the initial result does not satisfy the quality threshold, including which part of the metric is a cause, and (ii) execute the query using the AI-based search according to an extended query plan that reallocates computational resources; and
provide, via a voice-based agent, at least one of the initial result and an extended result from executing the query using the extended query plan.

10. The non-transitory computer-readable medium of claim 9, wherein the instructions to determine the quality of the initial result include instructions to analyze the initial result according to the metric that quantifies a number of sources, conflicting results, staleness of sources, reliability of sources, and bias of sources, and
wherein the quality indicates at least an accuracy and a relevance.

11. The non-transitory computer-readable medium of claim 9, wherein the instructions to acquire the query include instructions to receive a voice-based inquiry from a passenger within a vehicle, and wherein acquiring the query includes receiving sensor data from the vehicle.

12. The non-transitory computer-readable medium of claim 9, wherein the instructions to identify that the quality does not satisfy the quality threshold include instructions to compare a metric that quantifies the quality of the initial result against the quality threshold to ascertain when the initial result is not adequate.

13. The non-transitory computer-readable medium of claim 9, wherein the instructions to execute the query according to the initial query plan include instructions to execute the query using a limited set of resources to limit a temporal consumption of the query, and
wherein the AI-based search is a search engine that uses one or more machine-learning models in combination with resources, including documents, and online search engines.

14. A method, comprising:
executing a query acquired in a vehicle using an artificial intelligence (AI)-based search according to an initial query plan, wherein the initial query plan restricts the AI-based search to a limited set of local knowledge resources within a defined temporal threshold to limit a temporal consumption of the query;
determining a quality of an initial result of the query;
responsive to identifying that the quality of the initial result does not satisfy a quality threshold according to a metric, (i) providing, via a voice-based agent of the vehicle, an explanation of the quality that indicates why the initial result does not satisfy the quality threshold, including which part of the metric is a cause, and (ii) executing the query using the AI-based search according to an extended query plan that reallocates computational resources; and
providing, via a voice-based agent, at least one of the initial result and an extended result from executing the query using the extended query plan.

15. The method of claim 14, wherein determining the quality of the initial result includes analyzing the initial result according to the metric that quantifies a number of sources, conflicting results, staleness of sources, reliability of sources, and bias of sources, and
wherein the quality indicates at least an accuracy and a relevance.

16. The method of claim 14, wherein acquiring the query includes receiving a voice-based inquiry from a passenger within a vehicle, and wherein acquiring the query includes receiving sensor data from the vehicle.

17. The method of claim 14, wherein identifying that the quality does not satisfy the quality threshold includes comparing the metric that quantifies the quality of the initial result against the quality threshold to ascertain when the initial result is not adequate.

18. The method of claim 14, wherein executing the query according to the initial query plan includes executing the query using a limited set of resources to limit a temporal consumption of the query, and
wherein the AI-based search is a search engine that uses one or more machine-learning models in combination with resources, including documents, and online search engines.

19. The method of claim 14, wherein executing the query according to the extended query plan includes executing the query without temporal limitations to permit the AI-based search to explore additional resources and improve the quality.

20. The method of claim 14, wherein providing at least one of the initial result and the extended result includes controlling one or more systems within a vehicle to communicate with a passenger, modify an electronic calendar of the passenger, or alter a route for navigating the vehicle, and
wherein providing the explanation of the quality includes using a voice-based agent to communicate the explanation to the passenger.
